(19) United States
(12) Patent Application Publication
(10) Pub. No.: US 2026/0329677 A1
(43) Pub. Date: Oct. 22, 2026

(54) METHOD AND DEVICE FOR CALLING SERVICE COMPONENT, COMPUTER DEVICE, AND STORAGE MEDIUM

(71) Applicant: TCL MOBILE COMMUNICATION TECHNOLOGY (NINGBO) CO., LTD., Ningbo, Zhejiang (CN)

(72) Inventors: Xinyao YE, Ningbo, Zhejiang (CN); Min ZHANG, Ningbo, Zhejiang (CN); Zhanfeng PENG, Ningbo, Zhejiang (CN)

(73) Assignee: TCL MOBILE COMMUNICATION TECHNOLOGY (NINGBO) CO., LTD., Ningbo, Zhejiang (CN)

(21) Appl. No.: 19/109,570

(22) PCT Filed: Aug. 3, 2023
(86) PCT No.: PCT/CN2023/110905

§ 371 Date: Mar. 7, 2025

(30) Foreign Application Priority Data
Nov. 2, 2022 (CN) 202211360525.7

(51) Int. Cl. G06F 9/54

(52) U.S. Cl. CPC G06F 9/547

(57) ABSTRACT

A method and device for calling a service component, a computer device, and a storage medium are provided. The method responds to a calling request sent by different processes through a configured service component framework, acquires an interface implementation class of the service component based on configuration information, and then completes a call of a target service component through the interface implementation class.

This application claims priority to Chinese Patent Applications No. 202211360525.7, filed on Nov. 2, 2022 and entitled “SERVICE COMPONENT CALLING METHOD AND APPARATUS, AND COMPUTER DEVICE AND STORAGE MEDIUM”. The entire disclosures of the above application are incorporated herein by reference.

### TECHNICAL FIELD

This application relates to the field of artificial intelligence technologies, and specifically relates to a service component calling method and device, a computer device, and a storage medium.

### BACKGROUND TECHNOLOGY

With the development of technology, for terminal devices, especially mobile phone terminals, a variety of system functions are often added to an original Android native system to provide practicality of the terminal device. The system functions are usually customized and developed service components at a Framework layer of an Android system. However, the development of the service components requires adding and modifying code directly on a source code (Aosp) of the Android native system. This development method leads to serious coupling between the service component and the Android native system, which makes it difficult to maintain the code and achieve component reuse and transplantation.

### Technical Problem

The service component is severely coupled with the Android native system, which leads to technical problems such as difficulty in code maintenance and difficulty in achieving component reuse and transplantation.

### SUMMARY OF INVENTION

In a first aspect, the present application provides a method of calling a service component, which method includes:
loading configuration information of a service component framework.
in response to a calling request, acquiring a target service component corresponding to the calling request and an interface implementation class corresponding to the target service component based on the configuration information of the service component framework.
calling and executing a service function of the target service component through the interface implementation class.

In some embodiments of the present application, the configuration information includes a mapping table between an external call URL and an IExecutor interface implementation class.
the acquiring the target service component corresponding to the calling request and the interface implementation class corresponding to the target service component based on the configuration information of the service component framework includes:
acquiring a target external call URL in the calling request through the service component framework.
looking up a target IExecutor interface implementation class corresponding to the target external call URL from the mapping table.

In some embodiments of the present application, the calling request is a calling request of an application process.
the acquiring the target service component corresponding to the calling request and the interface implementation class corresponding to the target service component based on the configuration information of the service component framework includes:
acquiring a target external call URL in the calling request through the service component framework.
sending the target external call URL in the calling request to a Binder service of a system service process.
looking up a target IExecutor interface implementation class corresponding to the target external call URL from the mapping table through the Binder service of the system service process.

In some embodiments of the present application, the calling and executing the service function of the target service component through the interface implementation class includes:
instantiating the target IExecutor interface implementation class to obtain a first object instance.
executing the first object instance to call an application program interface of the target service component.

In some embodiments of the present application, the configuration information includes an IService interface implementation class list.
after loading the configuration information of the service component framework, the method further includes:
reading the IService interface implementation class list in the configuration information through the service component framework.
instantiating an IService interface implementation class in the IService interface implementation class list to obtain a second object instance.
executing the second object instance to enable the service function of the target service component.

In some embodiments of the present application, the loading the configuration information of the service component framework includes:
acquiring a configuration file of the service component.
when the configuration file includes an IExecutor configuration file, loading an external call URL in the IExecutor configuration file and an IExecutor interface implementation class corresponding to the external call URL to obtain a mapping table between the external call URL and the IExecutor interface implementation class.
when the configuration file includes an IService configuration file, loading a class name of the IService interface implementation class in the IService configuration file to obtain an IService interface implementation class list.

In some embodiments of the present application, before loading the configuration information in a configuration file of the service component, the method includes:
in a compilation process of the service component, scanning first annotation information related to a system service and second annotation information related to an application program interface in the service component.
generating an IService interface implementation class corresponding to the system service based on the first annotation information, and generating an IService configuration file according to a class name of the IService interface implementation class.
generating an external call URL corresponding to the application program interface and an IExecutor interface implementation class corresponding to the external call URL based on the second annotation information, and generating an IExecutor configuration file according to the external call URL and the IExecutor interface implementation class corresponding to the external call URL.

In a second aspect, the present application provides a device for calling a service component, which includes:
a configuration loading module configured to load configuration information of a service component framework.
an interface acquisition module configured to response to a calling request, and acquire a target service component corresponding to the calling request and an interface implementation class corresponding to the target service component based on the configuration information of the service component framework.
a function implementation module configured to call and execute a service function of the target service component through the interface implementation class.

In a third aspect, the present application also provides a computer device, which includes:
one or more processors.
a memory.
one or more application programs, where the one or more application programs are stored in the memory and configured to be executed by the processor to implement the method for calling the service component.

In a fourth aspect, the present application also provides a computer-readable storage medium on which a computer program is stored, and the computer program is loaded by a processor to execute steps in the method for calling the service component.

### Beneficial Effects

In the method and device for calling the service component, the computer device, and the storage medium, after loading the configuration information of the service component framework, in response to the calling request, the target service component corresponding to the calling request and the interface implementation class corresponding to the target service component are acquired based on the configuration information of the service component framework; the service function of the target service component is called and executed through the interface implementation class. The configured service component framework is configured to respond to the calling requests sent by different processes, and the interface implementation class of the service component is acquired based on the configuration information. Then, the target service component is called through the interface implementation class without establishing a corresponding relationship with any process, which realizes decoupling of the service component from other components or applications in an Android system and improves reusability of the service component.

### BRIEF DESCRIPTION OF THE DRAWINGS

To describe technical solutions in embodiments of the present application clearly, the following briefly describes accompanying drawings required for illustrating the embodiments of the present application. Apparently, the accompanying drawings described in the following description illustrate only some embodiments of the present application, and a person skilled in the art may derive other accompanying drawings based on these accompanying drawings without creative efforts.

FIG. 1 is a schematic flowchart of a method for calling a service component in an embodiment of the present application.

FIG. 2 is a schematic flowchart of an interface implementation class acquisition steps in an embodiment of the present application.

FIG. 3 is a schematic diagram of calling a service component in an embodiment of the present application.

FIG. 4 is another schematic diagram of calling a service component in an embodiment of the present application.

FIG. 5 is another schematic diagram of calling a service component in an embodiment of the present application.

FIG. 6 is a schematic flowchart of another pixel information acquisition step in an embodiment of the present application.

FIG. 7 is a schematic diagram of a structure of a device for calling a service component in an embodiment of the present application.

FIG. 8 is a schematic diagram of a structure of a computer device in an embodiment of the present application.

### DETAILED DESCRIPTION OF THE EMBODIMENTS

The technical solution in the embodiments of the present application will be clearly and completely described below with reference to the accompanying drawings in the embodiments of the present application. Apparently, the described embodiments are only some of the embodiments of the present application, but not all of the embodiments. Based on the embodiments in the present application, all other embodiments obtained by those skilled in the art without making creative efforts shall fall within the scope of protection of the present application.

In the description of the present application, terms “first” and “second” are used for descriptive purposes only and cannot be understood as indicating or implying relative importance or implicitly indicating the number of indicated technical features. Thus, features defined as “first” and “second” may explicitly or implicitly include one or more of the described features. In the description of the present application, “plurality” means two or more, unless otherwise explicitly and specifically limited.

In the description of the present application, the word “such as” is used to mean “serving as an example, illustration, or illustration.” Any embodiment described as “such as” in the present application is not necessarily to be construed as preferred or advantageous over other embodiments. The following description is presented to enable any person skilled in the art to make and use the invention. In the following description, details are set forth for the purpose of explanation. It will be understood by one of ordinary skill in the art that the present invention may be practiced without these specific details. In other instances, well-known structures and processes have not been described in detail to avoid obscuring the description of the invention with unnecessary detail. Thus, the present invention is not intended to be limited to the embodiments shown but is to be accorded the widest scope consistent with the principles and features disclosed in the present application.

The present application provides a method for calling a service component, which can be applied to a terminal device. The terminal device can be a mobile phone, a tablet computer, or a laptop computer. The terminal device runs an Android system or an operating system that is forward compatible with the Android system. The service component can be understood as a software module for implementing a certain service function. The service component is a software module or software function at an Android framework level, and can also be called a framework component.

Generally speaking, one service component usually includes two sub-components: a service sub-component and a framework sub-component. The service sub-component includes a SystemService implementation class and an application program interface (API) called by other services (AMS, PMS, etc.). The SystemService implementation class is an implementation class of the service component that implements a corresponding system service. A code of the service sub-component can run in a system service process. The framework sub-component usually only includes the application program interface called by external applications. The framework sub-component can call the service sub-component through aidl to implement the implementation class of the corresponding system service. A code of the framework sub-component can run in all Java processes.

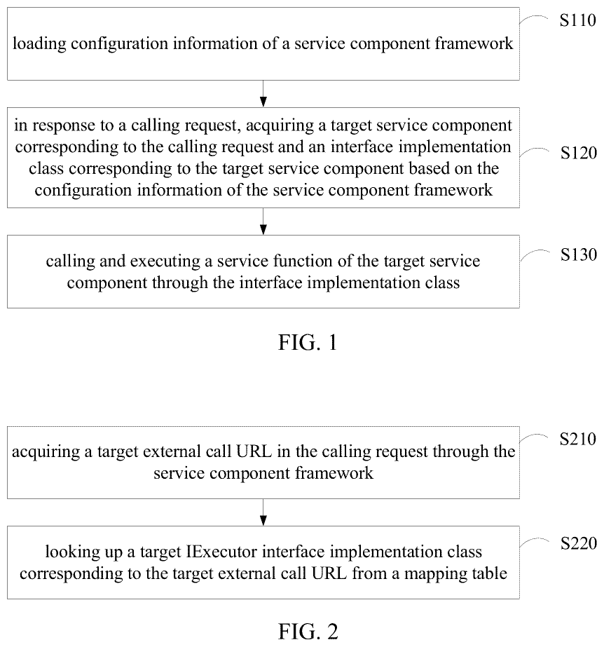

Referring to FIG. 1, an embodiment of the present application provides a method for calling a service component, which is mainly illustrated by applying the method to the above-mentioned terminal device. The method includes steps S110 to S130, which are specifically as follows:

Step S110, loading configuration information of a service component framework.

The service component framework can be configured to receive different processes, such as a service management process in the Android system or a third-party calling request to call different service components. The configuration information includes but is not limited to a full class name of a service component implementation class, an interface implementation class configured to call a corresponding API of different service components, etc. In one embodiment, the configuration information includes an IService interface implementation class list, and a mapping table between an external call URL and an IExecutor interface implementation class. The IService interface implementation class list includes class names of multiple IService interface implementation classes. The IService interface implementation class refers to an implementation class of an interface of the SystemService implementation class configured to enable a service function corresponding to the service component. The service component framework can enable the SystemService implementation class of the corresponding service component through the class name of the IService interface implementation class to enable the service component to implement the corresponding service function. The external call URL refers to a URL string corresponding to an API of the service component, including but not limited to a URL corresponding to an API of the service sub-component of the service component and a URL corresponding to an API of the framework sub-component. The IExecutor interface is an interface for calling the API of the service component. The IExecutor interface implementation class is an implementation class for implementing the interface for calling the API of the service component.

The service component framework is loaded by loading its configuration information. After the service component framework is loaded, a system service management process and an application process of a third-party application can call different service components through the service component framework, so that the service component executes the corresponding service function and/or acquires an execution result of the service component.

Step S120, in response to a calling request, acquiring a target service component corresponding to the calling request and an interface implementation class corresponding to the target service component based on the configuration information of the service component framework.

The target service component is a service component requested by the calling request. The interface implementation class corresponding to the service component refers to a class for calling the corresponding APIs of different service components. For example, the interface implementation class corresponding to the service component can be a class for implementing the API for calling the service sub-component in the service component, or it can be a class for implementing the API for calling the framework sub-component in the service component.

Specifically, the system service management process or the application process of a third-party application can initiate a calling request. After receiving the calling request, the service component framework looks for the target service component called by the calling request and the interface implementation class of the target service component according to the pre-loaded configuration information, and then calls the API of the target service component through the interface implementation class or directly enables the target service component through the interface implementation class.

Step S130, calling and executing a service function of the target service component through the interface implementation class.

Different service components can be configured to implement different service functions. After determining the interface implementation class of the target service component, the interface implementation class can be instantiated to acquire a corresponding object instance, and then execute the object instance. That is, an interface method corresponding to the interface implementation class is executed to call the corresponding API of the target service component and execute the service function of the target service component.

In the above method for calling the service component, after loading the configuration information of the service component framework, in response to the calling request, the target service component corresponding to the calling request and the interface implementation class corresponding to the target service component are acquired based on the configuration information of the service component framework. The service function of the target service component is called and executed through the interface implementation class. The configured service component framework is configured to respond to the calling request sent by an Android native system or an application. Also, based on the configuration information, the interface implementation class of the service component is acquired. Then, the call of the target service component is completed through the interface implementation class. The service component does not need to establish a corresponding relationship with the Android native system or the application, which realizes decoupling of the service component from the Android native system or the application and improves reusability of the service component.

As described above, the configuration information includes a mapping table between an external call URL and an IExecutor interface implementation class. In one embodiment, as shown in FIG. 2, the step of acquiring the target service component corresponding to the calling request and the interface implementation class corresponding to the target service component based on the configuration information of the service component framework include:

Step S210, acquiring a target external call URL in the calling request through the service framework.

Step S220, looking up a target IExecutor interface implementation class corresponding to the target external call URL from the mapping table.

The calling request includes the external call URL of a corresponding API of the target service component. After receiving the calling request initiated by the system service process or the application process of the third-party application, the service component framework acquires the target external call URL in the calling request, and looks up the target IExecutor interface implementation class corresponding to the target external call URL from the mapping table according to the target external call URL. If the target IExecutor interface implementation class can be found in the mapping table, the service function of the target service component is executed through the target IExecutor interface implementation class.

Furthermore, the step of calling and executing the service function of the target service component through the interface implementation class includes: instantiating the target IExecutor interface implementation class to obtain a first object instance; and executing the first object instance to call an application program interface of the target service component.

The application program interface of the target service component is the API of the target service component, including the API of the framework sub-component and the API of the service sub-component corresponding to the service component.

Specifically, after looking up the target IExecutor interface implementation class corresponding to the target external call URL from the mapping table, the target IExecutor interface implementation class can be instantiated to acquire the corresponding first object instance, and then execute the first object instance to call the API of the target service component through the target IExecutor interface, so that the target service component executes the corresponding service function.

More specifically, when the target external call URL is an external call URL of the application program interface of the service sub-component in the service component, the service component framework looks up the target IExecutor interface implementation class corresponding to the target external call URL from the mapping table. Then, the target IExecutor interface implementation class is instantiated to acquire the corresponding first object instance. Also, the first object instance is executed to call the API of the corresponding service sub-component of the target service component through the target IExecutor interface, so that the target service component executes the corresponding service function.

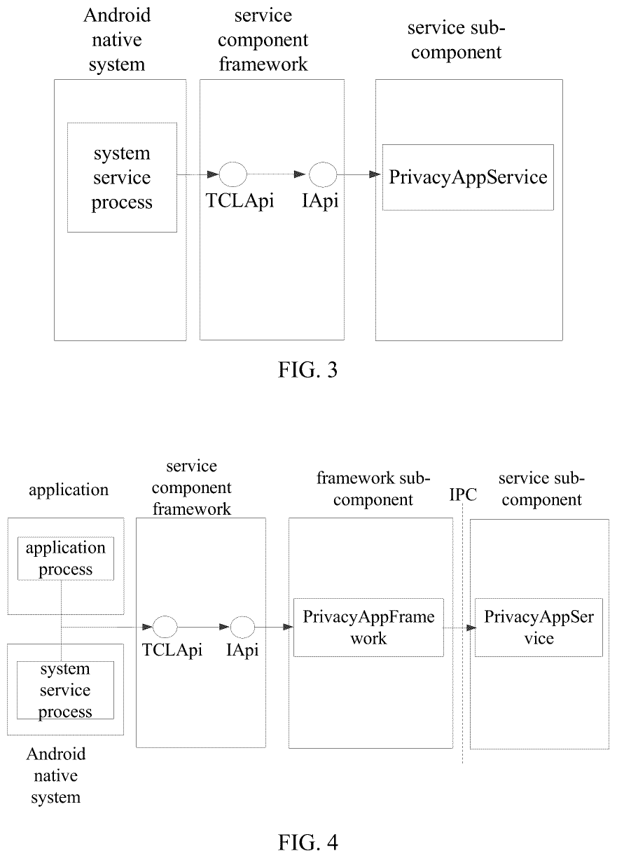

For example, referring to FIG. 3 and FIG. 4, a node TCLApi in the service component framework is configured to look up the IExecutor interface implementation class corresponding to the external call URL from the mapping table. A node IApi is configured to execute the object instance corresponding to the IExecutor interface implementation class to call the API of the service component. As shown in FIG. 3, upon receiving the calling request initiated by the system service process, the node TCLApi of the service component framework acquires the target external call URL in the calling request, and looks up the target IExecutor interface implementation class corresponding to the target external call URL from the mapping table according to the target external call URL. The node IApi instantiates the target IExecutor interface implementation class to acquire the corresponding first object instance, and executes the first object instance to implement the call of the API corresponding to the service sub-component of the target service component through the target IExecutor interface, so that the target service component executes the corresponding service function. For another example, as shown in FIG. 4, upon receiving the calling request initiated by the system service process or the application process, the node TCLApi of the service component framework acquires the target external call URL in the calling request, and looks up the target IExecutor interface implementation class corresponding to the target external call URL from the mapping table based on the target external call URL. The node IApi instantiates the target IExecutor interface implementation class to acquire the corresponding first object instance, and executes the first object instance to implement the call of the API corresponding to the framework sub-component of the target service component through the target IExecutor interface. The framework sub-component can call the service sub-component corresponding to the target service component through an Android AIDL, so that the target service component executes the corresponding service function.

As described above, during the process of calling the service component by the application process, it is necessary to implement the API call to the framework sub-component of the service component through the service component framework, and then call the service sub-component corresponding to the service component through AIDL based on the framework sub-component. In order to further reduce the workload of code writing for component development of the service component, the service component framework provided by the embodiment of the present application also provides a cross-process service component calling method to avoid calling the service sub-component corresponding to the service component through the framework sub-component during the process of calling the service component by the application process. In one embodiment, in response to the calling request, the step of acquiring the target service component corresponding to the calling request and the interface implementation class corresponding to the target service component based on the configuration information of the service component framework includes: acquiring a target external call URL in the calling request through the service component framework; sending the target external call URL in the calling request to a Binder service of a system service process; and looking up a target IExecutor interface implementation class corresponding to the target external call URL from the mapping table through the Binder service of the system service process.

The system service process in the Android system holds a Binder service client of the application process. The application process can communicate with the system service process through Binder and send a Binder service object of the application process, so that the system service process holds a proxy of the Binder service client of the application process. Therefore, the service component framework can connect to the system service process through Binder communication. After receiving the calling request initiated by the application process of the third-party application, the service component framework acquires the target external call URL in the calling request. When the target external call URL is the external call URL of the API of the service component corresponding to the service sub-component, the service component framework can send the target external call URL to the Binder service of the system service process, so that the Binder service of the system service process can proxy the call to the service component.

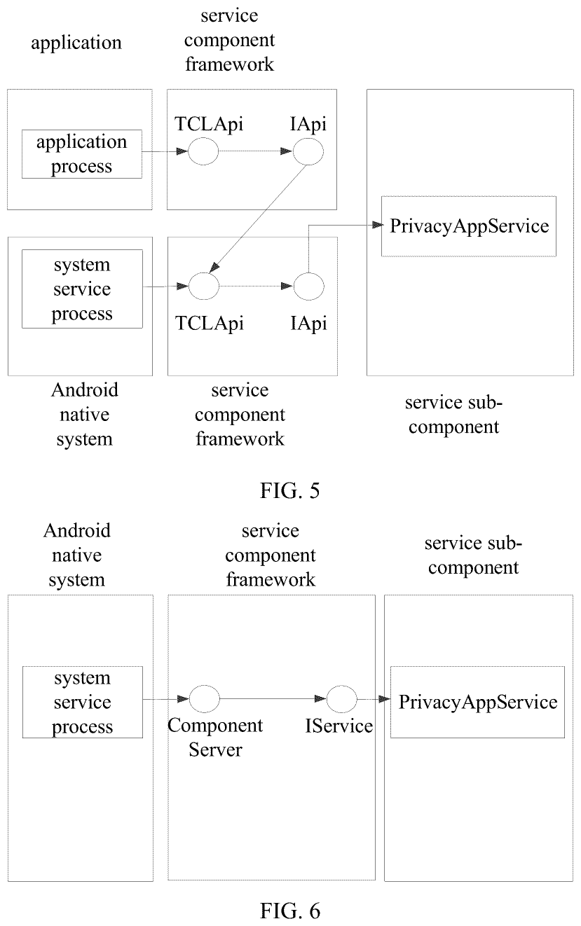

Specifically, after the service component framework sends the target external call URL to the Binder service of the system service process, the Binder service of the system service process looks up the target IExecutor interface implementation class corresponding to the target external call URL from the mapping table through the corresponding service component frame. Then, the target IExecutor interface implementation class is instantiated to acquire the corresponding first object instance, and the first object instance is executed to implement the call of the API of the corresponding service sub-component of the target service component through the target IExecutor interface, so that the target service component executes the corresponding service function and implements a cross-process call of the service sub-component API of the service component, as shown in FIG. 5.

In order to implement the service function, some service functions can be implemented by directly calling the API of the service component that implements the service function, while some service functions often need to enable the service component first to execute the corresponding service function and save the execution result after the execution is completed. When the service component is called by the system service management process or the application process of the third-party application, the execution result of the service component is returned to the system service management process or the application process of the third-party application.

Therefore, in one embodiment, before the step of acquiring the target service component corresponding to the calling request and the interface implementation class corresponding to the target service component based on the configuration information of the service component framework, it includes: reading an IService interface implementation class list in the configuration information; instantiating an IService interface implementation class in the IService interface implementation class list to obtain a second object instance; and executing the second object instance to enable the service function of the target service component.

Specifically, the system service process can read the IService interface implementation class list in the configuration information through the service component framework to acquire a full name of the implementation class of the IService interface implementation class in the IService interface implementation class list. Then, the corresponding IService interface implementation class is acquired based on the full name of the implementation class, and these IService interface implementation classes are instantiated to obtain the corresponding second object instance. Then, the second object instance is executed to enable the service function of the target service component, and the service component is automatically enabled without adding a code for enabling the service component in the Android system source code (Aosp), so that the execution result of the service component can be directly acquired when the subsequent system service process or application process calls the service component. As shown in FIG. 6, a node ComponentServer in the service component framework is configured to obtain the full name of the implementation class of the IService interface implementation class in the IService interface implementation class list. A node IServic is configured to execute the corresponding object instance of the IServicinterface implementation class to call the API of the service sub-component in the service component to enable the service function of the target service component.

In one embodiment, the step of loading the configuration information of the service component framework may specifically include: acquiring a configuration file of the service component; when the configuration file includes an IExecutor configuration file, loading an external call URL in the IExecutor configuration file and an IExecutor interface implementation class corresponding to the external call URL to obtain a mapping table between the external call URL and the IExecutor interface implementation class; when the configuration file includes an IService configuration file, loading a class name of the IService interface implementation class in the IService configuration file to obtain an IService interface implementation class list.

Specifically, the service component framework can look up the configuration files in jar packages corresponding to all service components. When there is the IExecutor configuration file in the configuration file, the external call URL in the IExecutor configuration file and the IExecutor interface implementation class corresponding to each external call URL are read and loaded to generate the mapping table between the external call URL and the IExecutor interface implementation class. When there is the IService configuration file in the configuration file, the class name of the IService interface implementation class in the IService configuration file is read and loaded to obtain the IService interface implementation class list.

Taking the enabling of a Zygote process of the Android system as an example, in a process of enabling the Zygote process of the Android system, it is often necessary to load the configuration information of the framework sub-component of the service component. Therefore, the service component framework acquires the jar packages of all service components corresponding to the framework sub-component, and looks up the IExecutor configuration file in the configuration file in the jar packages. When there is an IExecutor configuration file in the configuration file, the external call URL in the IExecutor configuration file and the IExecutor interface implementation class corresponding to each external call URL are read and loaded to generate the mapping table between the external call URL and the IExecutor interface implementation class.

For another example, taking the enabling of the system service process as an example, the enabling of the system service process often requires loading the framework sub-component of the service component and the configuration information of the service sub-component. Therefore, the service component framework acquires the jar packages of all framework sub-components and service sub-components corresponding to the service component, and looks up the IExecutor configuration file and the IService configuration file in the configuration file in the jar packages. When there is an IExecutor configuration file in the configuration file, the external call URL in the IExecutor configuration file and the IExecutor interface implementation class corresponding to each external call URL are read and loaded to generate the mapping table between the external call URL and the IExecutor interface implementation class. When there is an IService configuration file in the configuration file, the class name of the IService interface implementation class in the loaded IService configuration file is configured to obtain the IService interface implementation class list. Furthermore, for the configuration information of the framework sub-component, the system service process can be forked by the Zygote process, without parsing and acquiring the configuration file of the jar package of the framework sub-component.

Furthermore, before the step of loading the configuration information in the configuration file of the service component, it includes: in a compilation process of the service component, scanning first annotation information related to a system service and second annotation information related to an application program interface in the service component; generating an IService interface implementation class corresponding to the system service based on the first annotation information, and generating an IService configuration file according to a class name of the IService interface implementation class; generating an external call URL corresponding to the application program interface and an IExecutor interface implementation class corresponding to the external call URL based on the second annotation information, and generating an IExecutor configuration file according to the external call URL and the IExecutor interface implementation class corresponding to the external call URL.

Specifically, during a service component development process, for a component Serivce of the service component, an annotation @ServiceEvent can be configured to annotate the SystemService implementation class of the component Serivce to obtain the first annotation information. Furthermore, in the compilation process of the service component, information of the @ ServiceEvent annotation (i.e., the first annotation information) in the service component can be scanned and acquired. The IService interface implementation class is generated based on the information of the @ServiceEvent annotation. The IService interface implementation class can enable the SystemService class. Finally, the class name of the IService interface implementation class is written into one configuration file in the jar package corresponding to the component Serivce.

Similarly, during the service component development process, for the component Serivce and the framework sub-component of the service component, an annotation @Api can be configured to annotate each API of the component Serivce and the framework sub-component to obtain the second annotation information. Furthermore, in the compilation process of the service component, information of the @Api annotation (i.e., the second annotation information) in the service component can be scanned and acquired. The IExecutor interface implementation class is generated based on the information of the @Api annotation. The IExecutor interface implementation class can complete the call to the corresponding API. Finally, the external call URL of the Api and the IExecutor interface implementation class are written to one configuration file in the corresponding jar package of the component Serivce or the framework sub-component. By annotating the interface implementation class in the service component, the corresponding interface implementation class can be quickly generated when the service component is subsequently compiled, reducing a coding workload of the service component.

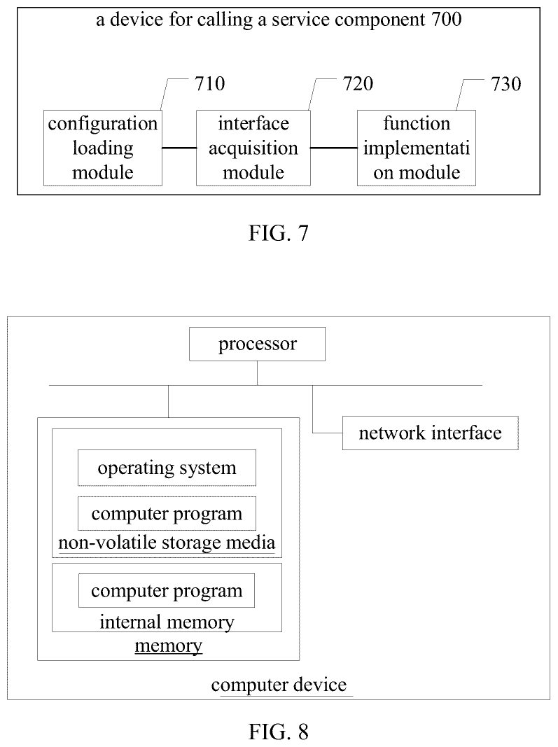

In order to better implement the method for calling the service component provided by the embodiments of the present application, on the basis of the method for calling the service component provided by the embodiments of the present application, an embodiment of the present application further provides a device for calling a service component, as shown in FIG. 7, where a device for calling a service component 700 includes:
a configuration loading module 710 configured to load configuration information of a service component framework.
an interface acquisition module 720 configured to response to a calling request, and acquire a target service component corresponding to the calling request and an interface implementation class corresponding to the target service component based on the configuration information of the service component framework.

a function implementation module 730 configured to call and execute a service function of the target service component through the interface implementation class.

In some embodiments of the present application, the configuration information includes a mapping table between an external call URL and an IExecutor interface implementation class; the interface acquisition module is specifically configured to: acquire a target external call URL in the calling request through the service component framework; look up a target IExecutor interface implementation class corresponding to the target external call URL from the mapping table.

In some embodiments of the present application, the calling request is a calling request of an application process; the interface acquisition module is specifically configured to: acquire a target external call URL in the calling request through the service component framework; send the target external call URL in the calling request to a Binder service of a system service process; look up a target IExecutor interface implementation class corresponding to the target external call URL from the mapping table through the Binder service of the system service process.

In some embodiments of the present application, the function implementation module is specifically configured to: instantiate the target IExecutor interface implementation class to obtain a first object instance; execute the first object instance to call an application program interface of the target service component.

In some embodiments of the present application, the configuration information includes an IService interface implementation class list; the configuration loading module is specifically configured to: read the IService interface implementation class list in the configuration information through the service component framework; instantiate an IService interface implementation class in the IService interface implementation class list to obtain a second object instance; execute the second object instance to enable the service function of the target service component.

In some embodiments of the present application, the configuration loading module is specifically configured to: acquire a configuration file of the service component; when the configuration file includes an IExecutor configuration file, load an external call URL in the IExecutor configuration file and an IExecutor interface implementation class corresponding to the external call URL to obtain a mapping table between the external call URL and the IExecutor interface implementation class; when the configuration file includes an IService configuration file, load a class name of the IService interface implementation class in the IService configuration file to obtain an IService interface implementation class list.

In some embodiments of the present application, the configuration loading module is specifically configured to: n a compilation process of the service component, scan first annotation information related to a system service and second annotation information related to an application program interface in the service component; generate an IService interface implementation class corresponding to the system service based on the first annotation information, and generate an IService configuration file according to a class name of the IService interface implementation class; generate an external call URL corresponding to the application program interface and an IExecutor interface implementation class corresponding to the external call URL based on the second annotation information, and generate an IExecutor configuration file according to the external call URL and the IExecutor interface implementation class corresponding to the external call URL.

In some embodiments of the present application, the device for calling the service component 700 may be implemented in the form of a computer program. The computer program may be run on a computer device as shown in FIG. 8. A memory of the computer device may store various program modules constituting the device for calling the service component 700, such as the configuration loading module 710, the interface acquisition module 720, and the function implementation module 730 shown in FIG. 7. The computer program composed of the various program modules enables the processor to execute the steps in the method for calling the service component of various embodiments of the present application described in this specification.

For example, the computer device shown in FIG. 8 can perform the step S110 through the configuration loading module 710 in the device for calling the service component 700 shown in FIG. 7. The computer device can perform the step S120 through the interface acquisition module 720. The computer device can perform the step S130 through the function implementation module 730. The computer device includes a processor, a memory, and a network interface connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The network interface of the computer device is configured to communicate with an external computer device through a network connection. When the computer program is executed by the processor, the method for calling the service component is implemented.

Those skilled in the art will appreciate that a structure shown in FIG. 8 is merely a block diagram of a portion of a structure related to the present application solution, and does not constitute a limitation on the computer device to which the present application solution is applied. A specific computer device may include more or fewer components than those shown in the figure, or combine certain components, or have a different arrangement of components.

In some embodiments of the present application, a computer device is provided, including one or more processors; a memory; and one or more applications. The one or more applications are stored in the memory, and the processor is configured to execute the steps of the method for calling the service component. The steps of the method for calling the service component may be the steps of the method for calling the service component in each of the above embodiments.

In some embodiments of the present application, a computer-readable storage medium is provided, which stores a computer program. The computer program is loaded by a processor, so that the processor executes the steps of the above-mentioned method for calling the service component. Here, the steps of the method for calling the service component can be the steps of the method for calling the service component in each of the above-mentioned embodiments.

Those skilled in the art can understand that all or part of the processes in the above-mentioned embodiment methods can be completed by instructing the relevant hardware through a computer program. The computer program can be stored in a non-volatile computer-readable storage medium. When the computer program is executed, it can include the processes of the embodiments of the above-mentioned methods. Any reference to memory, storage, database or other media used in the embodiments provided by the present application can include at least one of non-volatile and volatile memory. The non-volatile memory can include a read-only memory (ROM), a magnetic tape, a floppy disk, a flash memory, or an optical memory, etc. The volatile memory can include a random access memory (RAM) or an external cache memory. As an illustration and not limitation, the RAM can be in various forms, such as static random access memory (SRAM) or dynamic random access memory (DRAM).

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above is a detailed introduction to the method and device for calling the service component, the computer device, and the storage medium provided by the embodiments of the present application. The principle and implementation method of the present invention are described in detail using specific examples. The description of the above embodiments is only used to help understand the method of the present invention and its core idea. At the same time, for those skilled in the art, according to the idea of the present invention, there will be changes in the specific implementation method and application scope. In summary, the content of this specification should not be understood as limiting the present invention.

1. A method for calling a service component, wherein the method comprises:
loading configuration information of a service component framework;
in response to a calling request, acquiring a target service component corresponding to the calling request and an interface implementation class corresponding to the target service component based on the configuration information of the service component framework;
calling and executing a service function of the target service component through the interface implementation class.

2. The method according to claim 1, wherein the configuration information comprises a mapping table between an external call URL and an IExecutor interface implementation class;
the acquiring the target service component corresponding to the calling request and the interface implementation class corresponding to the target service component based on the configuration information of the service component framework comprises:
acquiring a target external call URL in the calling request through the service component framework;
looking up a target IExecutor interface implementation class corresponding to the target external call URL from the mapping table.

3. The method according to claim 1, wherein the calling request is a calling request of an application process;
the acquiring the target service component corresponding to the calling request and the interface implementation class corresponding to the target service component based on the configuration information of the service component framework comprises:
acquiring a target external call URL in the calling request through the service component framework;
sending the target external call URL in the calling request to a Binder service of a system service process;
looking up a target IExecutor interface implementation class corresponding to the target external call URL from the mapping table through the Binder service of the system service process.

4. The method according to claim 2, wherein the calling and executing the service function of the target service component through the interface implementation class comprises:
instantiating the target IExecutor interface implementation class to obtain a first object instance;
executing the first object instance to call an application program interface of the target service component.

5. The method according to claim 4, wherein the acquiring the target external call URL in the calling request through the service component framework and the looking up the target IExecutor interface implementation class corresponding to the target external call URL from the mapping table comprise:
acquiring the target external call URL in the calling request through a node TCLApi of the service component framework, and looking up the target IExecutor interface implementation class corresponding to the target external call URL from the mapping table;
the instantiating the target IExecutor interface implementation class to obtain the first object instance, and the executing the first object instance to call the application program interface of the target service component comprise:
instantiating the target IExecutor interface implementation class through a node IApi of the service component framework to obtain the first object instance, and executing the first object instance to call the application program interface of the target service component.

6. The method according to claim 5, wherein the application program interface of the target service component comprises an API of a service sub-component corresponding to the target service component;
the executing the first object instance through the node IApi of the service component framework to call the application program interface of the target service component comprises:
executing the first object instance through the node IApi of the service component framework to call the API of the service sub-component corresponding to the target service component.

7. The method according to claim 5, wherein the application program interface of the target service component comprises an API of a framework sub-component corresponding to the target service component;
the executing the first object instance through the node IApi of the service component framework to call the application program interface of the target service component comprises:
executing the first object instance through the node IApi of the service component framework to call the API of the framework sub-component corresponding to the target service component, wherein the framework sub-component calls the service sub-component corresponding to the target service component through an Android AIDL.

8. The method according to claim 1, wherein the configuration information comprises an IService interface implementation class list;
after loading the configuration information of the service component framework, the method further comprises:
reading the IService interface implementation class list in the configuration information through the service component framework;
instantiating an IService interface implementation class in the IService interface implementation class list to obtain a second object instance;
executing the second object instance to enable the service function of the target service component.

9. The method according to claim 1, wherein the loading the configuration information of the service component framework comprises:
acquiring a configuration file of the service component;
when the configuration file comprises an IExecutor configuration file, loading an external call URL in the IExecutor configuration file and an IExecutor interface implementation class corresponding to the external call URL to obtain a mapping table between the external call URL and the IExecutor interface implementation class.

10. The method according to claim 1, wherein the loading the configuration information of the service component framework comprises:
acquiring a configuration file of the service component;
when the configuration file comprises an IExecutor configuration file, loading an external call URL in the IExecutor configuration file and an IExecutor interface implementation class corresponding to the external call URL to obtain a mapping table between the external call URL and the IExecutor interface implementation class;
when the configuration file comprises an IService configuration file, loading a class name of the IService interface implementation class in the IService configuration file to obtain an IService interface implementation class list.

11. The method according to claim 1, wherein before loading the configuration information in a configuration file of the service component, the method comprises:
in a compilation process of the service component, scanning first annotation information related to a system service and second annotation information related to an application program interface in the service component;
generating an IService interface implementation class corresponding to the system service based on the first annotation information, and generating an IService configuration file according to a class name of the IService interface implementation class;
generating an external call URL corresponding to the application program interface and an IExecutor interface implementation class corresponding to the external call URL based on the second annotation information, and generating an IExecutor configuration file according to the external call URL and the IExecutor interface implementation class corresponding to the external call URL.

12. A device for calling a service component, wherein the device comprises:
a configuration loading module configured to load configuration information of a service component framework;
an interface acquisition module configured to response to a calling request, and acquire a target service component corresponding to the calling request and an interface implementation class corresponding to the target service component based on the configuration information of the service component framework;
a function implementation module configured to call and execute a service function of the target service component through the interface implementation class.

13. The device according to claim 12, wherein the configuration information comprises a mapping table between an external call URL and an IExecutor interface implementation class; the interface acquisition module is configured to:
acquire a target external call URL in the calling request through the service component framework; look up a target IExecutor interface implementation class corresponding to the target external call URL from the mapping table.

14. The device according to claim 12, wherein the calling request is a calling request of an application process; the interface acquisition module is configured to:
acquire a target external call URL in the calling request through the service component framework;
send the target external call URL in the calling request to a Binder service of a system service process;
look up a target IExecutor interface implementation class corresponding to the target external call URL from the mapping table through the Binder service of the system service process.

15. The device according to claim 13, wherein the function implementation module is configured to:
instantiate the target IExecutor interface implementation class to obtain a first object instance;
execute the first object instance to call an application program interface of the target service component.

16. The device according to claim 12, wherein the configuration information comprises an IService interface implementation class list; the configuration loading module is configured to:
read the IService interface implementation class list in the configuration information through the service component framework;
instantiate an IService interface implementation class in the IService interface implementation class list to obtain a second object instance;
execute the second object instance to enable the service function of the target service component.

17. The device of claim 12, wherein the configuration loading module is configured to:
acquire a configuration file of the service component;
when the configuration file comprises an IExecutor configuration file, load an external call URL in the IExecutor configuration file and an IExecutor interface implementation class corresponding to the external call URL to obtain a mapping table between the external call URL and the IExecutor interface implementation class;
when the configuration file comprises an IService configuration file, load a class name of the IService interface implementation class in the IService configuration file to obtain an IService interface implementation class list.

18. The device of claim 12, wherein the configuration loading module is configured to:
in a compilation process of the service component, scan first annotation information related to a system service and second annotation information related to an application program interface in the service component;
generate an IService interface implementation class corresponding to the system service based on the first annotation information, and generate an IService configuration file according to a class name of the IService interface implementation class;
generate an external call URL corresponding to the application program interface and an IExecutor interface implementation class corresponding to the external call URL based on the second annotation information, and generate an IExecutor configuration file according to the external call URL and the IExecutor interface implementation class corresponding to the external call URL.

19-20. (canceled)

21. The device according to claim 12, wherein the calling request is a calling request of an application process;
wherein the interface acquisition module is configured to:
acquire a target external call URL in the calling request through the service component framework;
send the target external call URL in the calling request to a Binder service of a system service process;
look up a target IExecutor interface implementation class corresponding to the target external call URL from the mapping table through the Binder service of the system service process.

22. The device according to claim 15, wherein the function implementation module is configured to:
acquire the target external call URL in the calling request through a node TCLApi of the service component framework, and look up the target IExecutor interface implementation class corresponding to the target external call URL from the mapping table.
